(19) United States
(12) Patent Application Publication
(10) Pub. No.: US 2013/0232130 A1
(43) Pub. Date: Sep. 5, 2013

(54) COMPANY NETWORK

(71) Applicant: Harald Jellum, Oslo (NO)

(72) Inventor: Harald Jellum, Oslo (NO)

(73) Assignee: COMPANYBOOK AS, Oslo (NO)

(21) Appl. No.: 13/634,945

(22) PCT Filed: Mar. 18, 2011
(86) PCT No.: PCT/NO2011/000093

§ 371 Date: Oct. 16, 2012

(30) Foreign Application Priority Data
Mar. 18, 2010 (NO) 20100399

(51) Int. Cl. G06F 17/30

(52) U.S. Cl. CPC G06F 17/30864
USPC 707/706

(57) ABSTRACT

Method and arrangement for Connecting Business using a database and search & matching technology for aiding companies in finding and maintaining relationships with customers, partners and other contacts so as to improve efficiency. This is performed by continuously searching the web sites including company web sites, official registers, financial registers, news, blogs, social networks and feedback from users. This is filtered and matched through advanced search and matching technology and published in a social media with corresponding communication, information sharing and marketing services.

### APPLICATION AREA

The invention is a completely new method for enterprises to find and maintain relations with customers, partners or other business contacts. The market for the invention is for local and for global enterprises that wish to find new customers, generate more business and work more efficiently with connections to their partners, distributors or other business contacts. The invention will be applicable to enterprises of all sizes and their employees. The enterprises can be in the public or private sector. The invention is made available to the users via a portal on the internet.

### PRIOR ART

### Social Media:

For the past few years there has been a strong growth of social media. These are, in the main, directed towards the individual, either as a private individual or as a professional. Examples of social media for private individuals are: Facebook, MySpace, Twitter and more. For the professional, one has LinkedIn, Xing, FastPitch and more. Standard for all these social media is that the user loads his profile himself and connects to others by inviting, or be invited by, others. Typical for all these networks is that not everybody is included. If you shall find new contacts you search among those that are already registered. Another important point is that these are not made particularly for enterprises, they are for individuals only.

### Enterprise Information—Catalogues

Another technology which exists is catalogue services for both private individuals and enterprises. Many of these have started with paper catalogues which have later developed into electronic versions that exist as internet portals. Examples of this can be Yellow Pages, 1881, Compass, Your District, Summa with others. Typical for these is that here one finds all enterprises based on publicly available information, (for example, from the Brønnøysund Business Register of Norway). These do not have the option one has with social media of connecting up into a network, and also that they contain limited sets of information as this is only based on public registers together with possible bought space for advertising/description. If you shall search for an enterprise in these portals you are dependent on the enterprises having put in exactly the key word you are looking for. Very often this is very limited in terms of the products and services the enterprises are involved in.

### Enterprise Information—Financial

Over the last few years a number of portals have arrived that have specialised in financial information. These contain key financial figures, accounts, credit information and any financial analysis. All of this is based on the last account sent into the public registers. Examples of this are Purehelp, Proff and D&B, CreditSafe with others. Typical for this sector is the inability to connect to networks and the shortage of non-financial information.

### Enterprise Information—Search Engines

Enterprises with web pages are indexed by internet search engines which means that the users can search using key words to look for an enterprise. Typical for these is that one gets much information from sources other than the enterprise's own web pages, one can not connect up into a net work and one cannot not find information from public registers that lie in databases.

An example of the prior art is shown in US 2008/005073, which describes a method to find and maintain contacts in a social network. More specifically, the publication relates to storing and adapting search strategies based on other search results and the use of these. These results are stored and are used to improve new searches so that the searches are better adjusted to the individual user and user groups.

### In General

None of the above mentioned solutions contains an automatic way to suggest new customers, partners or other business contacts. They are much more static and based on pure entries and do not have the automatic “understanding” of who you are, your surroundings, what is happening, who the others are and with whom and when you should meet them.

### WHAT CAN BE ACHIEVED WITH REGARD TO PRIOR ART

Based on what is available of different technologies today, this invention contains a completely new way to find and maintain customers, partners or other business contacts. The invention automatically finds new potential customers, partners or other business contacts. Based on all information about the enterprise, the market, existing customers, partners and business contacts, the invention automatically will be able to recommend relevant new potential customers, partners or other business contacts, and also maintain the relationships with these.

### MEANS THAT ARE NECESSARY

The invention uses database, advanced search & matching technology integrated into a social media platform.

### INDUSTRIAL APPLICATION

The invention can thereby achieve an efficient information treatment by monitoring and updating information about commercial players in a market. This can lead to great savings with regard to the way in which the business and business networks are procured today. Today, much is often created by incidental connections without an analysis of all the possibilities as this is too resource demanding and not easily available.

The invention will be described in more detail with reference to the enclosed figures that illustrate the invention with the help of examples.

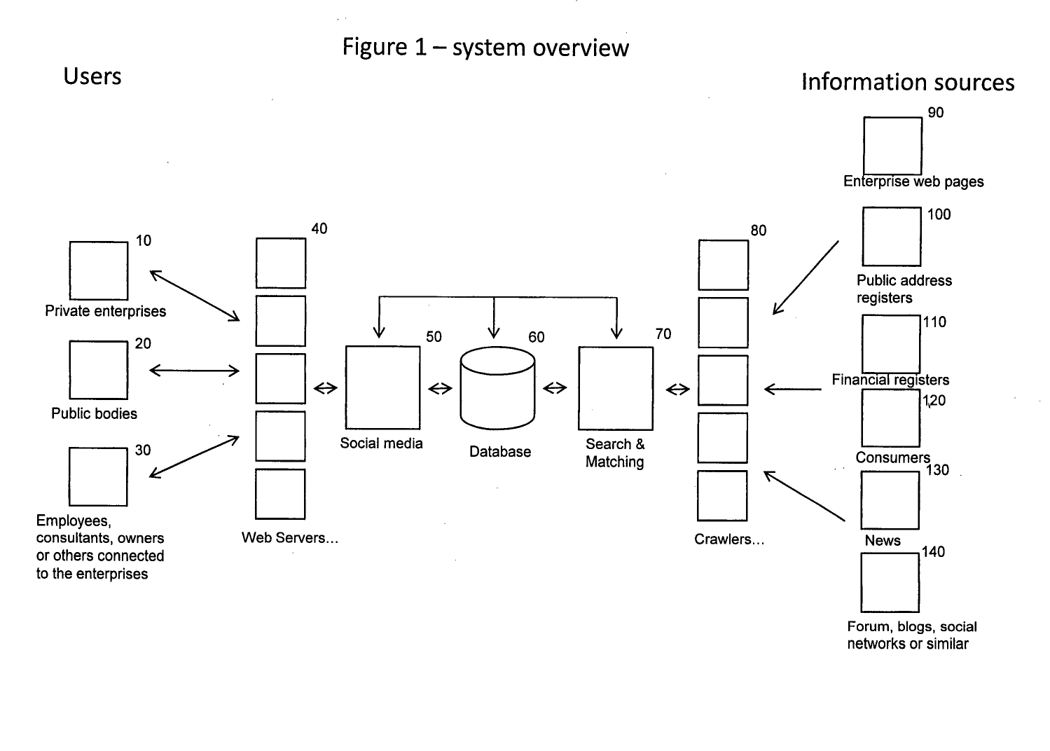

FIG. 1 shows a schematic presentation of the system according to a preferred embodiment of the invention.

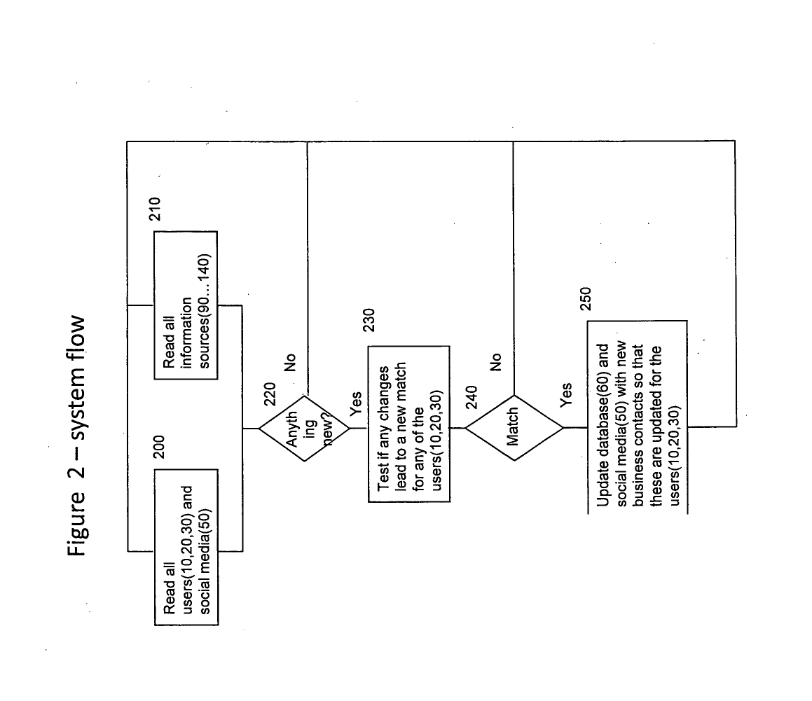

FIG. 2 shows a flow diagram that illustrates a preferred embodiment of the method according to the invention.

### DESCRIPTION OF THE INVENTION

Based on what is described above, there is a need for a more efficient way to find and maintain new business opportunities. This is particularly important when the economy takes a downturn and the competition stiffens. The above mentioned problems are addressed by the invention that is described in the following.

The invention is a completely new way for enterprises to find and maintain relationships with customers, partners or other business contacts. The invention is based on the use of database, advanced search & matching technology combined with social media. Starting from FIG. 1 the invention comprises a large server farm comprising the servers for Crawlers (80), Search & Matching (70), database (60), Social Media (50) and Web servers (40). These servers are operated by an ASP supplier that provides a service where the number of servers is automatically scaled according to the load in the system (for example, “Cloud Computing”). The purpose of the Crawlers (80) is initially to read all the sources of information (90,100,110,120,130,140) to store these in the database (60). Thereafter, the Crawlers (80) will continuously read all the information sources (90,100,110,120,130,140) for changes and updates. These are also stored in the Database (60).

The information sources comprise the Web pages (90) of the enterprises which are crawled as from a standard search engine. The biggest difference is that in the invention the Search & Matching (70) will perform a filtering of the web content to remove as much noise as possible, such as, for example, advertisements from other domains, and in addition, categorise the content according to a structure as, for example, the menu structure on the web pages and store this in the database (60). Public registers (100) and Financial registers (110) are both accessible registers for addresses, contacts and financial information such as accounts figures and credit information. Some of the registers will be in the public domain while others can be private and access must be purchased. There may be several registers within each of the information sources (100, 110). The users (120) can be other enterprises, employees, or private individuals who provide feedback on an enterprise. This can be, for example, feedback to a firm of lawyers that you have used and which you think did good job and which you wish to recommend. News (130) comprises a news flow which is continuously updated with news from newspapers, magazines, radio, TV, organisations, local councils, directorates, political parties and the like. This service is delivered by available third party suppliers in the market (for example, MoreOver, Retriever, Cyberwatcher or others). Search & Matching (70) will filter out all news that relates to enterprises and store this news in the database (60) together with associated activities. In the same way as with News (60), one will also get a stream of news from Forum, Blogs, Social Network (140) delivered by third party suppliers. The users (10,20,30) of the invention will reach the invention via an internet portal which is made available via Web servers (40). When the database (60) has received all the information from the information sources (90,100,110,130,140), with the exception of the Users (120) that arrived on the way when the invention is in use, all the users (10,20) will receive a personalised email (from email addresses from the web pages (90) of the enterprises and/or public registers (100)). This email links up to a profile for the enterprise that is set up in advance and which enables you to become a user within a few clicks. As a user of the invention you can now invite your customers, partners or other business contacts to be part of your customer group, partner group or other group that you have set up. This is in the same way as in other social media for private individuals. In this way you create a network of your business contacts. One of the unique properties of this invention is that with all this information from all the information sources (90,100,110,120,130,140), your network which you have created via the social media (50) and with Search & Matching (70) in combination with Database (60), is automatically to be able to propose new customers, partners or other business connections.

This automatic understanding is based on the system knowing much about each enterprise. Where it is located, what it is involved with, what is written in the media, what kinds of customers and partners it has, when the network was set up, how much dialogue there is between the enterprises. With the invention your new customers, partners or other business contacts that match your need will automatically be suggested.

The system flow of the invention is described in FIG. 2. All the information sources are read (210) together with all users and everything in the social media (200). If there is no news (220) the reading of all information sources and users (200,210) will continue, but if there is some news (220) a test of the change will lead to a new match for some of the users (230) being carried out. If this leads to a new match (240), the database and social media are updated with new business contacts so that these are updated for the users (250). The reading of all information sources and all users and social media (200,210) is then continued.

The invention also comprises a series of other characteristics that concerns efficiently taking care of your contacts and being visible to your environment.

The users (10,20,30) can set up groups to which they can invite their customers, partners or other business contacts. This takes place via social media (50). After these groups have been set up, one can communicate and share information with Chat, email, messages, forum, sharing of documents.

The users (10,20,30) can search for other enterprises via Search & Matching (70). The searches are smart in that you do not have to search many different sources to collect all the information about an enterprise. The invention provides you with hits with information from all the information sources (90,100,110,120,130,140). The information is categorised so that one can easily navigate to what one is looking for. The hits are collected in categories for sectors, revenue, result, location, number of employees or other relevant set-ups. The users (10,20,30) can also search with whole sentences and content that describes what they are looking for. Such as, for example, “firm of lawyers in Oslo that is expert in EU tax law”.

The networks that are set up by Social media (50) are also intelligent in that they follow all information about those that are in your network and tell you whether somebody is in financial difficulties. This is checked continuously by Search & Matching (70) which all the time checks all available information about the enterprises in your network. An example can be an enterprise which is in your customer group and which suddenly gets a lot of press coverage (130) about lay-offs and cut-backs. You will then get this as an early warning message through social media (50).

Other important characteristics are the possibility each user (10,20,30) has to create a “showroom” where they can upload text, sound and videos about the enterprise, indicate the most relevant search words that both become visible within the invention itself and also on other search engines such as Google, Bing or others. They can also establish blogs that are completely open or open to selected groups only, send press statements or personalised messages to a selection of other enterprises, make banner advertisements that are personalised to branches and a selection within the invention or that are distributed onto the internet via third part operators, sharing and connecting of your profile within the invention with external social media such as Facebook, Twitter, LinkedIn or others so that what is happening within the one social medium is automatically reflected to the others. Users (10,20,30) will also get a complete overview and statistics on who, when and how long other users (10,20,30) have been looking at your profile.

To sum up, the present invention relates to a Method and arrangement for “Connecting Business” by the use of modern Database, Search & Matching technology integrated with Social Media that makes it possible for enterprises to find and maintain relationships with customers, partners and other business contacts. The invention comprises a method and arrangement encompassing a combination of database, advanced search & matching technology combined with social media;
a) Where the search engine continuously reads the web pages (90) of the enterprises, public business registers (100), financial registers (110) news (130), forum (140), blogs (140), social networks (50) and feedback from users (120). These enterprises can be selected from certain criteria or the search engine can be a general search engine that examines everything available and is fitted with criteria that characterise typical enterprise web pages.
b) The collected information is categorised according to chosen criteria and stored in a database (60).
c) The collected information is thereafter made available in an electronic network, a so-called social network (50).
d) The social network is made available via an internet portal with restricted access for members of the social network, for example, for chosen players comprising, for example, private individuals (10), public bodies (20), employees, consultants, owners or others connected to the enterprise (30)
e) and which, through a continuous search and matching (70) of all changes in the social network (50), updates in the database (60), finds new customers, partners, or other business contacts.
f) For members or others selected in the network, the web page will provide possibilities of communication where the information collected by the search engine can be maintained or corrected, similar to maintaining the relationship with customers, partners or other business associations via efficient communication, information sharing and marketing methods. Thus, the information which is shared and adapted by the users of the system is separated from the information that is provided about non-users of the search engine.

For those who wish to participate in the network, an increased influence over the information is thereby given, while information about business activities that are not part of the social network is also accessible in the database based on the content the search engine has extracted from web pages and similar available information.

Via searches, comparisons, and collection of information (search & matching (70)) it becomes possible for the users (10,20,30) to search in all enterprises with data from all information sources (90-140) in such a way that the hits can be sorted and categorised according to the sector, location, revenue, result, number of employees, products or other typical for the business. Search & matching (70) also makes it possible for the user (10,20,30) to search with whole sentences, other enterprises, news, documents or other descriptions of the kind of enterprise one is looking for and the social media (50) makes it possible for the users (10,20,30) to create closed groups with customers, partners or other business contacts.

The social medium comprises means to let the users (10,20,30) exchange information, for example, by sending out messages, chat, setting up a common forum, sharing documents with the group(s) they are part of, and the database (60) can make it possible for the users (10, 20, 30) to be able to upload text, sound and videos about themselves to a showroom that is made accessible to other users.

The Search & matching routine (70), the database (60) and the social medium (50) can also make it possible for the users (10,20,30) to receive automatic warnings (Early warning) if some of their customers, partners or other business contacts have financial difficulties. The database (60) and search & matching (70) make it possible for the users (10,20,30) to be able to describe themselves by the most important search words to make it easier for others to find them, both within the invention and on the internet in other search engines. Thereby, the database (60) and search & matching (70) make it possible for the users (10,20,30) to market themselves through carrying out a selection of searches and thereafter sending out a personalised message to all the enterprises that are in the search selection, via sharing its profiles with other external social networks, and/or sending out a press release to a network of enterprises within the invention or via external players that have a ready network for press releases.

According to a preferred embodiment of the invention the database (60) also makes it possible for the users (10,20,30) to view the statistics of who, when and what others have seen of your profile or to show banner advertisements within the network according to the invention or externally via third party players with a network to different media channels. It will also be possible through the database (60) and search & matching (70) to make it possible for the users (10,20,30) automatically to become search engines optimised for other external search engines on the internet with all the content from everybody.

1. A method for information gathering in a business network by the use of modern Database, Search and Matching technology integrated with Social Media that enables enterprises to find and maintain relations with customers, partners or other business contacts, where the method comprises the use of:
a database, a search engine and means for information comparisons for use in social media;
wherein:
a) the search engines continuously reads the web pages of the enterprises, public enterprise registers, financial registers, news, forum, blogs, social networks and feedback from the users;
b) and where this information is categorised and stored in a database;
c) and is made available to a social network;
d) where the social network is made available via an internet portal with restricted access;
e) execution of repeated attempts with regard to point a) and a comparison with stored information for the detection of all changes in the social network, updates in the database finds new customers, partners or other business contacts; and
f) to provide a communication with chosen users to allow maintenance of the information in the database.

2. The method according to claim 1, wherein the search and matching makes it possible for the users to search in all enterprises with data from all the information sources in such a way that the hits can be sorted and categorised according to sector, location, sales, result, number of employees, products or others typical for enterprises.

3. The method according to claim 1, wherein the search and matching makes it possible for the users to search with whole sentences, other enterprises, news, documents or other descriptions of the type of enterprise one is looking for.

4. The method according to claim 1, wherein the Social media makes it possible for the users to set up closed groups with customers, partners or other business associations.

5. The method according to claim 1, wherein the Social media makes it possible for users to send messages, chat, set up common forums, share documents with the group(s) they are part of.

6. The method according to claim 1, wherein the search and matching, database and social media make it possible for users to receive automatic warnings (Early warning) if any of their customers, partners or other business contacts have financial difficulties.

7. The method according to claim 1, wherein the database makes it possible for the users to be able to upload text, sound and videos about themselves to a showroom that is made available to other users.

8. The method according to claim 1, wherein the database and search and matching make it possible for the users to be able to describe themselves by the most important search words to make it simpler for others to find them both within the invention and out on the internet in other search engines.

9. The method according to claim 1, wherein the database and search and matching make it possible for the users to market themselves by making a search selection and thereafter sending out a personalised message to all enterprises that are in the search selection.

10. The method according to claim 1, wherein the database and search and matching make it possible for the users to market themselves by sending out a press statement to a network of enterprises within the invention or via external enterprises that have a network set up for press releases.

11. The method according to claim 1, wherein the database and Social media make it possible for the users to share their profiles with other external social networks.

12. The method according to claim 1, wherein the database makes it possible for users to view statistics of who, when and what others have seen of your profile.

13. The method according to claim 1, wherein the database makes it possible for the users to show banner advertisements within the invention or externally via third party enterprises with a network for different media channels.

14. The method according to claim 1, wherein the database and search and matching make it possible for the users automatically to be search engine optimised for other external search engines on the internet with all the content from all the information sources.

15. A system for information gathering in a business network by the use of modern Database, Search and Matching technology integrated with Social Media that enables enterprises to find and maintain relations with customers, partners or other business connections, where the system comprises:
a database, a search engine and means for information comparisons for use in social media;
wherein:
a) the search engine is essentially set up for continuous reading of the web pages of the enterprises, public business registers, financial registers, news, forum, blogs, social networks and feedback from the users;
b) the database is set up to categorise and store the categorised information;
c) the database comprises communication means connected to an electronic network;
d) where the electronic network comprises an internet portal with restricted access;
e) where the system is set up to carry out repeated searches with regard to point a) and a comparison with stored information for detection of all changes in the electronic network, updates in the database finds new customers, partners or other business contacts according to selected criteria, and storage of these in the database; and
f) where the system comprises means of communication to provide a communication with selected users to permit maintenance of the information in the database.
